(19) United States
(12) Patent Application Publication
(10) Pub. No.: US 2001/0046931 A1
(43) Pub. Date: Nov. 29, 2001

(54) Sheet folding device and method

(76) Inventor: Leonard D. Krueger, Granite Shoals, TX (US)

Correspondence Address: John R. Flanagan, FLANAGAN & FLANAGAN, P.O. Box 11300, Jackson Hole, WY, 83002, US

(21) Appl. No.: 09/824,293

(22) Filed: Apr. 2, 2001

Related U.S. Application Data
(60) Provisional application No. 60/194,286, filed on Apr. 3, 2000.

(51) Int. Cl. B31B 1/26

(52) U.S. Cl. 493/421

(57) ABSTRACT

A sheet folding device includes a platform and a pair of guides disposed along opposite sides of the platform. The platform has a multi-stepped profile in a lengthwise direction so as to define a lower shoulder and an upper shoulder disposed above and displaced in the lengthwise direction of the platform from the lower shoulder. The guides are provided for guiding placement of a sheet on the platform such that the sheet can be folded by (i) placing one edge of the sheet against one of the lower and upper shoulders, (ii) curling an opposite edge of the sheet and placing the opposite edge against the other of the lower and upper shoulders, and (iii) pressing the sheet downward onto itself on the platform so as to fold the sheet.

This patent application claims the benefit of U.S. provisional patent application No. 60/194,286 filed on Apr. 3, 2000.

### BACKGROUND OF THE INVENTION

1. Field of the Invention

The present invention generally relates to devices for folding a sheet of paper and, more particularly, is concerned with a sheet folding device and method.

2. Description of the Prior Art

A sheet of paper or a letter is typically sent in an envelope which requires that the letter first be folded to fit inside the envelope. The letter is commonly folded twice onto itself such that the letter is in three portions. These three portions include a middle portion and two end portions. The middle portion is on the bottom of the folded letter. One of the end portions is in the middle of the folded letter and is on top of the middle portion. The other of the end portions is on the top of the folded letter and is on top of the one end portion. Many greeting cards, especially homemade cards, are folded twice, with their folds in a perpendicular relationship, before they are fitted into an envelope. A problem exists, however, in that letters and greeting cards are difficult to fold square each time.

Large businesses which generate a high volume of letters have machines which automatically fold the letters. These devices, however, take up lots of space and are expensive for small businesses or individuals to own. Various devices have therefore been developed over the years which are relatively small in size and less expensive to own than those devices which are used by large businesses.

Representative examples of such more compact and economical letter folding devices and the like are disclosed in U.S. Pat. No. 192,102 to Watriss, U.S. Pat. No. 747,085 to Rieffel, U.S. Pat. No. 3,092,379 to Collier, U.S. Pat. No. 4,421,500 to Smith, U.S. Pat. No. 5,057,070 to Pidcock, U.S. Pat. No. 5,348,526 to Feygin, U.S. Pat. No. 5,378,222 to Weber, U.S. Pat. No. 5,380,265 to Giovinazzo et al. and U.S. Pat. No. 5,842,963 to Meesters. While many of these prior art letter folding devices and the like appear to provide a satisfactory solution for the problem at hand, none of them seem to provide an optimum degree of assistance for small businesses and individuals in the process of folding letters or greeting cards.

Consequently, a need remains for a sheet or letter folding device which would provide small businesses and individuals with a more cost-effective and economical solution to the aforementioned problem in the prior art without introducing any new problems in place thereof.

### SUMMARY OF THE INVENTION

The present invention overcomes the aforementioned problem by providing a sheet folding device which is relatively small in size, simple in its construction, effective in its use, and relatively inexpensive to manufacture. The device can be used with letters, greeting cards or any other type of sheet of paper or foldable sheet material. The device is particularly suitable for use by small businesses and individuals who need a space-efficient and cost-effective means of assistance in folding sheets, such as letters and greeting cards.

Accordingly, the present invention is directed to a sheet folding device which comprises a platform having a multi-stepped profile in a lengthwise direction so as to define a lower shoulder and an upper shoulder disposed above and displaced in the lengthwise direction of the platform from the lower shoulder such that a sheet can be folded by (i) placing one edge of the sheet against one of the lower and upper shoulders, (ii) placing an opposite edge of the sheet against the other of the lower and upper shoulders, and (iii) pressing the sheet downward onto itself on the platform to fold the sheet. The device further comprises a guiding means in the form of a pair of guide rail members disposed along opposite sides of the platform.

In one exemplary embodiment, the platform has an upper plate member, a lower plate member and a middle plate member disposed between the upper and lower plate members. Each of the plate members has a substantially flat configuration and increases in respective lengths going from the upper plate member to the lower plate member and the plate members are stacked one on top of the other so as to provide the multi-stepped lengthwise profile of the platform.

In another exemplary embodiment, the platform is a one-piece structure having three different levels defining upper, lower and middle portions. The upper shoulder extends between and in a transverse relation to the upper and middle portions. The lower shoulder extends between and in a transverse relation to the middle and lower portions.

The present invention further is directed to a sheet folding method which comprises the steps of (a) providing a platform having a multi-stepped profile in a lengthwise direction of the platform being defined by a lower shoulder and an upper shoulder disposed above and displaced in the lengthwise direction of the platform from the lower shoulder; (b) placing one edge of a sheet against one of the lower and upper shoulders of the platform; (c) curling an opposite edge of the sheet; (d) placing the opposite edge of the sheet against the other of the lower and upper shoulders of the platform; and (e) pressing the sheet downward onto itself on the platform to form a first fold in the sheet. The method further comprises the steps of: (f) rotating the sheet approximately 180 degrees in the lengthwise direction of the sheet; (g) placing the first fold of the sheet against one of the lower and upper shoulders; (h) curling the one edge of the sheet generally to the location of the first fold; and (i) pressing the sheet downward onto itself on the platform to form a second fold in the sheet.

These and other features and advantages of the present invention will become apparent to those skilled in the art upon a reading of the following detailed description when taken in conjunction with the drawings wherein there is shown and described an illustrative embodiment of the invention.

### BRIEF DESCRIPTION OF THE DRAWINGS

In the following detailed description, reference will be made to the attached drawings in which:

FIG. 1 is a longitudinal sectional view of a first exemplary embodiment of a letter folding device of the present invention.

FIG. 2 is a view similar to that of FIG. 1 showing a sheet of paper being folded once.

FIG. 3 is a view similar to that of FIGS. 1 and 2 showing the sheet of paper after being folded a second time.

FIG. 4 is a top plan view of a second exemplary embodiment of the device of the present invention.

FIG. 5 is a side elevational view of the device as seen along line 5-5 of FIG. 4.

### DETAILED DESCRIPTION OF THE INVENTION

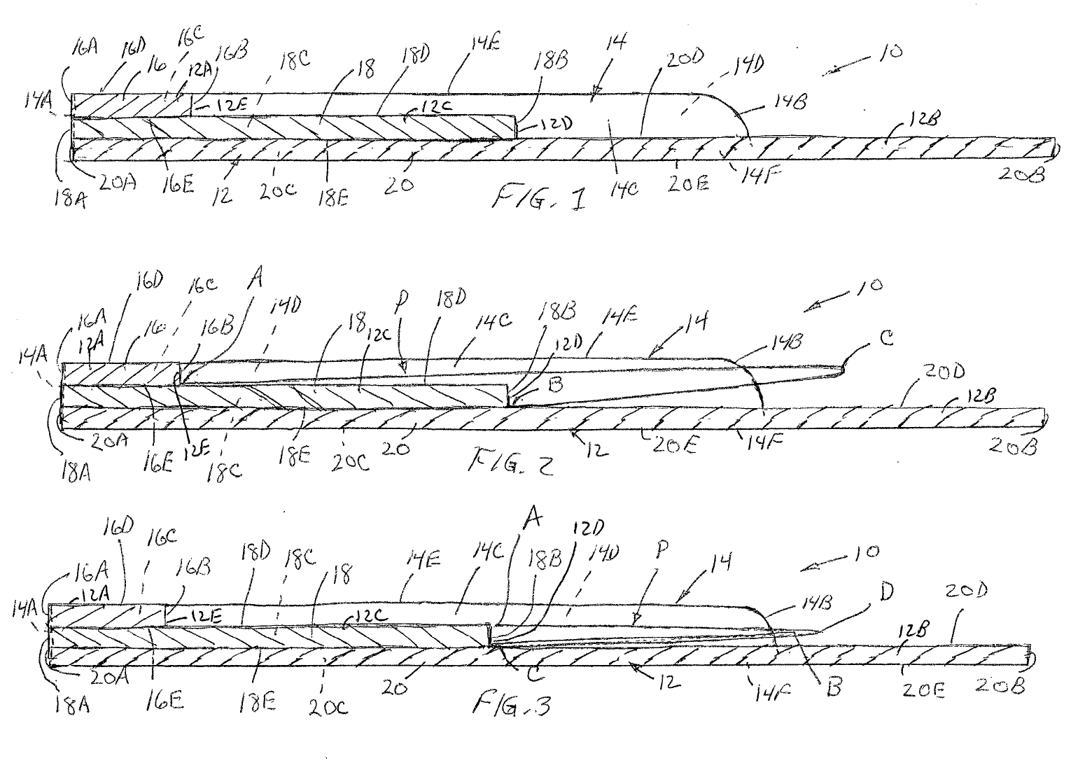

Referring to the drawings and particularly to FIGS. 1 to 5, there is illustrated two exemplary embodiments of a sheet folding device, generally designated 10, of the present invention. In both embodiments, the sheet folding device 10 basically includes a platform 12 having an upper portion 12A, a lower portion 12B, a middle portion 12C disposed between the upper and lower portions 12A, 12B, a lower shoulder 12D extending in a transverse relation to and between the lower and middle portions 12B, 12C, and an upper shoulder 12E extending in a transverse relation to and between the middle and upper portions 12C, 12A. The upper, middle and lower portions 12A, 12C, 12B and the upper and lower shoulders 12E, 12D provide the platform 12 with a multi-stepped profile in its lengthwise direction. The sheet folding device 10 also includes guiding means in the form of a pair of opposite of guide rail members 14 disposed along opposite sides of the platform 12.

In the first exemplary embodiment of the device 10 shown in FIGS. 1 to 3, the upper, middle and lower portions 12A, 12C, 12B of the platform 12 are three plate members, an upper plate member 16, a middle plate member 18 and a lower plate member 20, each having a substantially flat rectangular configuration. The plate members 16, 18 and 20 increase from one to the next in their respective lengths and are attached and stacked one on top of the other so as to provide the multi-stepped profile of the platform 12. The plate members 16, 18 and 20 can be fabricated as separate components that are attached together in any suitable known manner or molded as a single unit using conventional fabrication techniques.

More particularly, each of the upper, middle and lower plate members 16, 18 and 20 has a pair of opposite ends 16A, 16B; 18A, 18B; and 20A, 20B, a pair of opposite sides 16C, 18C and 20C, and opposite top and bottom surfaces 16D, 16E; 18D, 18E; and 20D, 20E. Also, each upper, middle and lower plate member 16, 18 and 20 has a length extending between the opposite ends thereof, a width extending between the opposite sides thereof, and a thickness extending between the top and bottom surfaces thereof. The widths of the plate members 16, 18 and 20 are substantially the same and the thicknesses of the plate member 16, 18 and 20 are substantially the same. The lengths of the plate members 16, 18 and 20 are different. The length of the lower plate member 20 is substantially greater than the lengths of the middle and upper plate members 18, 16. The length of the lower plate member 20 is greater than its width. The length of the middle plate member 18 is substantially greater than the length of the upper plate member 16. The width of the middle plate member 18 is greater than its length. The width of the upper plate member 16 is greater than its length.

The one opposite ends 16A, 18A and 20A of the upper, middle and lower plate members 16, 18 and 20 are flush with one another. The opposite sides 16C, 18C and 20C of the plate members 16, 18 and 20 are flush with one another. The other opposite ends 16B, 18B and 20B of the plate members 16, 18 and 20 are spaced from one another by the differences in their respective lengths such that the stacked upper, middle and lower plate members 16, 18 and 20 provide the multi-stepped profile of the platform 12. The other opposite end 18B of the middle plate member 18 is disposed closer to the other opposite end 16B of the upper plate member 16 than to the other opposite end 20B of the lower plate member 20. When the device 10 is placed for use on a surface of a table, desk or the like, each of the top surfaces 16D, 18D and 20D of the plate members 16, 18 and 20 face upwardly and each of the bottom surfaces 16E, 18E and 20E of the plate members 16, 18 and 20 face downwardly. The upper plate member 16 is mounted to the middle plate member 18 such that the top surface 16D of the upper plate member 16 is completely exposed while that the bottom surface 16E thereof is disposed on and against the top surface 18D of the middle plate member 18. Because of the substantially larger area of the top surface 18D of the middle plate member 18 than of the bottom surface 16E of the upper plate member 16, more of the top surface 18D of the middle plate member 18 is exposed than is covered by the upper plate member 16. The middle plate member 18 is mounted to the lower plate member 20 such that the bottom of the middle plate member 18 is disposed against the top surface 20D of the lower plate member 20. Because of the substantially larger area of the top surface 20D of the lower plate member 20 than of the bottom surface 18E of the middle plate member 18, more of the top surface 20D of the lower plate member 20 is exposed than is covered by the middle plate member 18. The lower plate member 20 at its bottom surface 20E is intended to rest on the surface of the table, desk or the like. The corners of the lower plate member 20 disposed between its other opposite end 20B and opposite sides 20C are rounded.

The guide rail members 14 (only one of which being shown in FIGS. 1 to 3) are substantially identical to one another. Each guide rail member 14 has opposite ends 14A, 14B, opposite inner and outer sides 14C, 14D and opposite upper and lower surfaces 14E, 14F. Each guide rail member 14 is mounted to the upper, middle and lower plate members 16, 18 and 20 such that the inner side 14C of the guide rail member 14 is against one of the opposite sides 16C, 18C and 20C of the plate members 16, 18 and 20. The one opposite end 14A of each guide rail member 14 is flush with the one opposite ends 16A, 18A and 20A of the plate members 16, 18 and 20. The upper surface 14E of each guide rail member 14 is flush with the top surface 16D of the upper plate member 16 and is disposed higher than the respective top surfaces 18D, 20D of the middle and lower plate members 18, 20. The lower surface 14F of each guide rail member 14 is flush with the bottom surface 20E of the lower plate member 20. The outer side 14D of each guide rail member 14 faces away from the opposite sides 16C, 18C and 20C of the plate members 16, 18 and 20. The corner of each guide rail member 14 disposed at the other opposite end 14B is rounded.

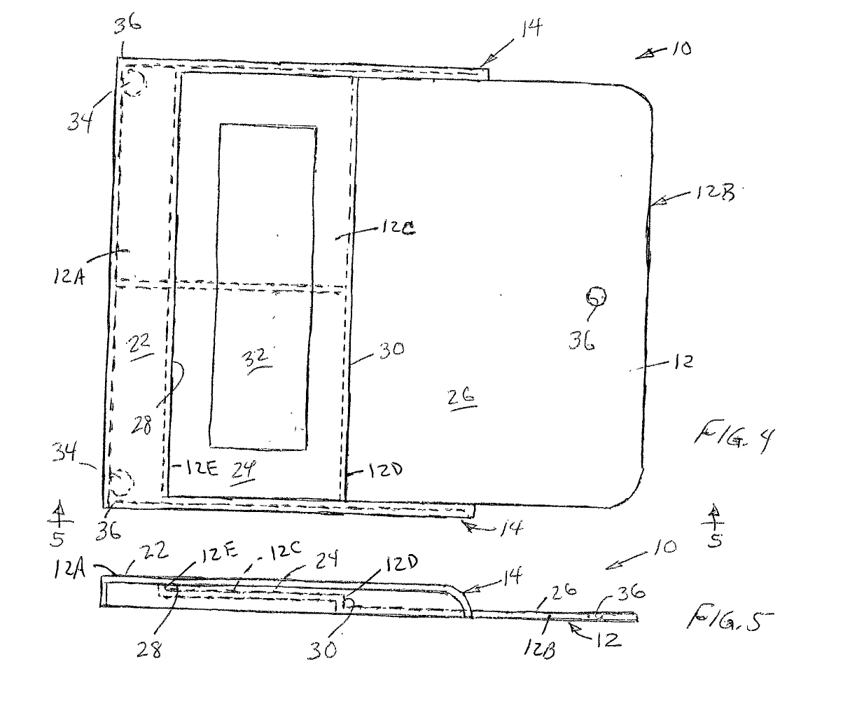

Referring to FIGS. 2 and 3, in operation, a letter or a card or a sheet of paper P may be folded twice. The sheet of paper P has a pair of opposite sides and opposite edges A and B at opposite ends thereof which extend between and interconnect the opposite sides. The sheet of paper P is inserted between and guided by the guide rail members 14 so as to place a leading edge A of the sheet of paper P in a desired position against the upper shoulder 12D or other opposite (vertical) end 16B of the upper plate member 16 and over the top surface 18D of the middle plate member 18. The opposite trailing edge B of the sheet of paper P is then curled under the sheet of paper P and placed in a desired position against the lower shoulder 12E or other opposite (vertical) end 18B of the middle plate member 18 and over the top surface 20D of the lower plate member 20. When the leading and trailing edges A and B of the sheet of paper P are in their respective positions, a first fold C may be created in the sheet of paper P upon a user pressing the sheet of paper P onto itself on the top surface 20D of the lower plate member 20, as shown in FIG. 2. The first fold C is disposed closer to the edge B than to the edge A of the sheet of paper P. Then, the sheet of paper P is rotated 180 degrees in its lengthwise direction and the first fold C of the sheet of paper P is placed against the lower shoulder 12E or other opposite end 18B of the middle plate member 18 and over the top surface 20D of the lower plate member 20. The edge B of the sheet of paper P is now disposed on top of and between the first fold C and edge A of the sheet of paper P and is disposed above the top surface 20D of the lower plate member 20. A second fold D may now be created in the sheet of paper P upon a user bringing or curling the edge A over and to the location of the first fold C and pressing the sheet of paper P onto itself upon the top surface 20D of the lower plate member 20, as shown in FIG. 3. The second fold D is disposed closer to the edge A than to the edge B of the sheet of paper P. A middle portion of the sheet of paper P extends between the first fold C and the second fold D and is disposed on the bottom of the folded sheet of paper P. One end portion of the sheet of paper P extends between the first fold C and the edge B and is disposed in the middle of the folded sheet of paper P. Another end portion of the sheet of paper P extends between the second fold D and the edge A and is disposed on top of the folded sheet of paper P. The sheet of paper P may also be folded in any other suitable manner and any other suitable number of times using the device 10. In the case of a twice folded greeting card, the sheet of paper P would be first folded in half and then turned ninety degrees and again folded in half.

In the second exemplary embodiment of the device 10 shown in FIGS. 4 and 5, the platform 12 and opposite guide rails 14 are fabricated, employing conventional molding techniques, as a one-piece structure having three different levels, upper level 22, middle level 24 and lower level 26, defining steps or the upper and lower shoulders 28 and 30. The upper, middle and lower levels 22, 24, 26 correspond to the upper, middle and lower plate members 16, 18, 20 of the first embodiment. The middle level 24 of the platform 12 also has a recessed area 32 for receiving and mounting a name plate. Pad supports 34 underlie the upper level 22 of the platform 12 adjacent to the corners 36 thereof. The lower level 28 of the platform 12 has a hole 36 formed therethrough for use in hanging the device 10 on a support structure, such as a wall or the like.

It should be understood that in forming the first fold C in the sheet S, the trailing edge B of the sheet S could first be placed against the lower shoulder 12D and then the leading edge A of the sheet S could next be curled over the sheet S and placed against the upper shoulder 12E and thereafter the first fold C made in the sheet S.

It is thought that the present invention and its advantages will be understood from the foregoing description and it will be apparent that various changes may be made thereto without departing from the spirit and scope of the invention or sacrificing all of its material advantages, the form hereinbefore described being merely preferred or exemplary embodiment thereof.

I claim:

1. A sheet folding device, comprising:
a platform having a multi-stepped profile in a lengthwise direction so as to define a lower shoulder and an upper shoulder disposed above and displaced in the lengthwise direction of said platform from said lower shoulder such that a sheet can be folded by (i) placing one edge of the sheet against one of said lower and upper shoulders, (ii) placing an opposite edge of the sheet against the other of said lower and upper shoulders and (iii) pressing the sheet downward onto itself on said platform to make a fold in the sheet.

2. The device of claim 1 wherein said platform has an upper plate member, a lower plate member and a middle plate member disposed between said upper and lower plate members, each of said plate members having a substantially flat configuration and increasing in respective lengths going from said upper plate member to said lower plate member and being stacked one on top of the other so as to provide said multi-stepped lengthwise profile of said platform.

3. The device of claim 1 wherein said platform is a one-piece structure having three different levels defining upper, lower and middle levels, said upper shoulder extending between and in a transverse relation to said upper and middle levels, said lower shoulder extending between and in a transverse relation to said middle and lower levels.

4. A sheet folding device, comprising:
(a) a platform having a multi-stepped profile in a lengthwise direction so as to define a lower shoulder and an upper shoulder disposed above and displaced in the lengthwise direction of said platform from said lower shoulder; and
(b) means disposed along opposite sides of said platform for guiding placement of a sheet on said platform such that the sheet can be folded by (i) placing one edge of the sheet against one of said lower and upper shoulders, (ii) curling an opposite edge of the sheet and placing the opposite edge against the other of said lower and upper shoulders and (iii) pressing the sheet downward onto itself on said platform to make a fold in the sheet.

5. The device of claim 4 wherein said platform has an upper plate member, a lower plate member and a middle plate member disposed between said upper and lower plate members, each of said plate members having a substantially flat configuration and increasing in respective lengths going from said upper plate member to said lower plate member and being stacked one on top of the other so as to provide said multi-stepped lengthwise profile of said platform.

6. The device of claim 4 wherein said platform is a one-piece structure having three different levels defining upper, lower and middle portions, said upper shoulder extending between and in a transverse relation to said upper and middle portions, said lower shoulder extending between and in a transverse relation to said middle and lower portions.

7. The device of claim 4 wherein said guiding means is a pair of guide rail members disposed along opposite sides of said platform.

8. A sheet folding device, comprising:
(a) a platform having an upper portion, a lower portion, a middle portion disposed between said upper and lower portions, a lower shoulder extending in a transverse relation to and between said lower and middle portions, and an upper shoulder extending in a transverse relation to and between said middle and upper portions such that said upper, middle and lower portions and said upper and lower shoulders provide said platform with a multi-stepped profile in a lengthwise direction of said platform; and
(b) a pair of opposite of guide rail members disposed along opposite sides of the platform such that a sheet of paper can be folded by (i) inserting the sheet between said guide rail members so as to place one edge of the sheet against one of said lower and upper shoulders, (ii) curling an opposite edge of the sheet and placing the opposite edge of the sheet against the other of said lower and upper shoulders, (iii) pressing the sheet downward onto itself on said platform to make a first fold in the sheet, (iv) rotating the folded sheet 180 degrees in the lengthwise direction of the sheet, (v) placing the first fold of the sheet against one of said lower and upper shoulders, (vi) curling the one edge of the sheet over and generally to the location of the first fold, and (vii) pressing the sheet downward onto itself upon said platform to make a second fold in the sheet.

9. The device of claim 8 wherein said upper, lower and middle portions are upper, lower and middle plate members each having a substantially flat configuration and increasing from one to the next in respective lengths and being stacked one on top of the other so as to provide said multi-stepped lengthwise profile of said platform.

10. A sheet folding method, comprising the steps of:
(a) providing a platform having a multi-stepped profile in a lengthwise direction of the platform being defined by a lower shoulder and an upper shoulder disposed above and displaced in the lengthwise direction of said platform from said lower shoulder;
(b) placing one edge of a sheet against one of the lower and upper shoulders of the platform;
(c) curling an opposite trailing edge of the sheet;
(d) placing an opposite edge of the sheet against the other of the lower and upper shoulders of the platform; and
(e) pressing the sheet downward onto itself on the platform to form a first fold in the sheet.

11. The method of claim 10 further comprising the steps of:
(f) rotating the sheet approximately 180 degrees in the lengthwise direction of the sheet;
(g) placing the first fold of the sheet against one of the lower and upper shoulders;
(h) curling the one edge of the sheet generally to the location of the first fold; and
(i) pressing the sheet downward onto itself on the platform to form a second fold in the sheet.
